(19) United States
(12) Patent Application Publication
(10) Pub. No.: US 2026/0220909 A1
(43) Pub. Date: Jul. 30, 2026

(54) IMAGE PROCESSING DEVICE, IMAGE PROCESSING METHOD, AND PROGRAM

(71) Applicant: Renesas Electronics Corporation, Tokyo (JP)

(72) Inventors: Motoki KIMURA, Tokyo (JP); Hirofumi OHTA, Tokyo (JP)

(21) Appl. No.: 19/404,899

(22) Filed: Dec. 1, 2025

(30) Foreign Application Priority Data
Jan. 29, 2025 (JP) 2025-013384

(51) Int. Cl. G06V 10/75; G06V 10/28; G06V 10/82

(52) U.S. Cl. CPC G06V 10/751; G06V 10/28; G06V 10/758; G06V 10/82

(57) ABSTRACT

An image processing device according to the present disclosure generates a second image by executing quantization processing on a first image, generates a feature map based on the second image, generates an existence probability map indicating distribution of existence probability of an object in the first image by using the feature map, performs matching determination processing that is processing of determining whether a value of each cell matches a fixed value for the feature map or the existence probability map, and performs dequantization processing on the feature map or the existence probability map based on a result of the matching determination processing.

### CROSS-REFERENCE TO RELATED APPLICATIONS

The disclosure of Japanese Patent Application No. 2025-013384 filed on Jan. 29, 2025 including the specification, drawings and abstract is incorporated herein by reference in its entirety.

### BACKGROUND

The present disclosure relates to an image processing device, an image processing method, and a program.

There is disclosed a technique listed below.

[Patent Document 1] Japanese Unexamined Patent Application Publication No. 2024-023030

A technique for obtaining information from an image by using a neural network has been developed. For example, Patent Document 1 discloses a semiconductor device capable of reducing the time required for image processing by a neural network. The semiconductor device of Patent Document 1 includes a memory for weight parameters in order to prevent transfer of the weight parameters from being a bottleneck in a neural network that processes an image.

### SUMMARY

In Patent Document 1, it is assumed that a memory for weight parameters can be provided. Embodiments to be described later have been made in view of such circumstances, and other problems and novel features will be apparent from the description of the present specification and the accompanying drawings.

An image processing device according to an embodiment quantizes an image and dequantizes a feature map obtained from the quantized image or an existence probability map generated using the feature map. A determination is made as to whether the value of a cell matches a fixed value, and dequantization is performed on the basis of the determination result.

According to the embodiment, a new technique for processing an image by using a neural network is provided.

### BRIEF DESCRIPTION OF THE DRAWINGS

FIG. 1 is a diagram illustrating an overview of an operation of an image processing device.

FIG. 2 is a block diagram illustrating a functional configuration of the image processing device.

FIG. 3 is a block diagram illustrating a hardware configuration of a computer that implements the image processing device.

FIG. 4 is a first diagram illustrating a configuration of a neural network.

FIG. 5 is a second diagram illustrating a configuration of a neural network.

FIG. 6 is a first flowchart illustrating a procedure of processing executed by the image processing device.

FIG. 7 is a second flowchart illustrating a procedure of processing executed by the image processing device.

FIG. 8 is a diagram illustrating a dequantization function determined based on a post-dequantization threshold value and an observation maximum value.

FIG. 9 illustrates a more specific configuration of the neural network illustrated in FIG. 4 for a case where the feature map is treated as a target map.

FIG. 10 illustrates a more specific configuration of the neural network illustrated in FIG. 5 for a case where the feature map is treated as a target map.

FIG. 11 is a diagram illustrating a configuration of the image processing device having an output unit.

### DETAILED DESCRIPTION

Hereinafter, embodiments of the present disclosure will be described in detail with reference to the drawings. In the drawings, the same or corresponding elements are denoted by the same reference numerals, and redundant description is omitted as necessary for clarity of description. In addition, unless otherwise described, values determined in advance such as predetermined values and threshold values are stored in advance in a storage device or the like accessible from a device using the values. Furthermore, unless otherwise described, the storage unit includes any number of one or more storage devices.

### <Overview>

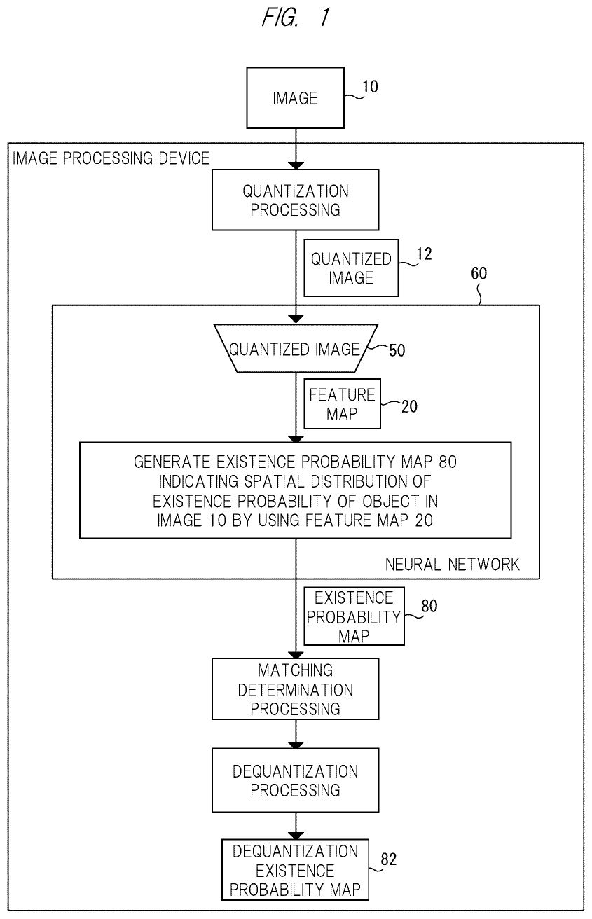

FIG. 1 is a diagram illustrating an overview of an operation of an image processing device 2000. Here, FIG. 1 is a diagram for facilitating understanding of the overview of the image processing device 2000, and the operation of the image processing device 2000 is not limited to that illustrated in FIG. 1.

The image processing device 2000 generates an existence probability map 80 from an image 10 by using a neural network 60. The neural network 60 is configured to output the existence probability map 80 in response to an input of an image. The existence probability map 80 indicates the existence probability of the object in each of the plurality of partial regions in the input image. Here, the existence probability only needs to be a value indicating the degree of likelihood of existence, and does not need to be a value indicating probability. Therefore, the existence probability can take a value larger than 1.

A quantized image 12 obtained by performing quantization processing on the image 10 is input to the neural network 60. Therefore, the image processing device 2000 performs quantization processing on the image 10 to generate the quantized image 12. In the quantization processing, the value of each pixel of the image 10 is quantized. Therefore, the quantized image 12 is an image in which the value of each pixel of the image 10 is quantized.

Here, the range of pixel values of the quantized image 12 may be different from the range of pixel values of the image 10. This is because the pixel value of the quantized image 12 and the pixel value of the image 10 can be represented by different data types. For example, the pixel value of the image 10 is represented by a 32-bit floating-point type, while the pixel value of the quantized image 12 is represented by an 8-bit integer type. Therefore, the pixel values of the image 10 are quantized so as to match the range of the pixel values in the quantized image 12. Hereinafter, the data type of the pixel values of the image 10 is referred to as a first data type, and the data type of the pixel values of the quantized image 12 is referred to as a second data type.

For example, the second data type is the same data type as that of the weight or bias (hereinafter, weight and the like) of the neural network 60. In this case, the quantization processing executed on the image 10 is also executed in advance on the weight and the like of the neural network 60. In this way, both the data type of the pixel values of the quantized image 12 input to the neural network 60 and the data type of the weight and the like of the neural network 60 become the second data type.

Note that the image 10 may be an image generated by a camera (hereinafter, a source image), or may be an image generated by executing various preprocessing on the source image. In the latter case, for example, the source image is an image in which each pixel is represented by an 8-bit integer for each of the R channel, the G channel, and the B channel. By executing preprocessing on the source image, the image 10 in which each pixel is represented by a 32-bit floating-point is generated.

The neural network 60 includes at least a feature extraction layer 50. The quantized image 12 or a feature map generated from the quantized image 12 is input to the feature extraction layer 50. The feature map is a tensor indicating a feature amount in each cell. The feature extraction layer 50 generates a feature map 20 from the input quantized image 12 or feature map. The feature extraction layer 50 includes, for example, a convolutional layer, a pooling layer, and the like.

The image processing device 2000 generates the existence probability map 80 from the feature map 20. A specific method of generating the existence probability map 80 from the feature map 20 will be described later.

Here, the image processing device 2000 performs dequantization processing for each cell of a specific map (hereinafter, a target map). The target map is, for example, the feature map 20 or the existence probability map 80.

The data type of the data after the dequantization is referred to as a third data type. The third data type is at least different from the second data type. The third data type may be the same as or different from the first data type. When the third data type is the same as the first data type, dequantization is performed such that the data type of the cell of the existence probability map 80 matches the data type of the cell of the image 10. Hereinafter, characters x, y, and z are used for the notation of the value of the first data type, the notation of the value of the second data type, and the notation of the value of the third data type, respectively.

Here, as a method of dequantization, there is a method of mapping a numerical range that can be taken by the value of the data type before the dequantization to a numerical range that can be taken by the value of the data type after the dequantization. For example, it is assumed that the value range of the second data type that is the data type before the dequantization is Y_min or more and Y_max or less. In addition, it is assumed that the value range of the third data type that is the data type after the dequantization is Z_min or more and Z_max or less. In this case, a linear function or the like that maps a numerical range of Y_min or more and Y_max or less to a numerical range of Z_min or more and Z_max or less is defined as the dequantization function.

On the other hand, in the image processing device 2000, the conversion of z which is the value of the cell after the dequantization and y which is the value of the cell before the dequantization is defined as quantization processing expressed by the following Formula (1). The dequantization processing by the image processing device 2000, that is, the conversion from y which is the value before the dequantization to z which is the value after the dequantization is also processed using the correspondence relationship of Formula (1).

$$[ Math . 1 ]$$

$$y = \{ \begin{matrix}{dq}^{- 1} ( z ) & z > Th \\ C & z \leq Th\end{matrix} \qquad ( 1 )$$

Here, dq\hat{ }−1(z) is a quantization function. Th is a predetermined value referred to as a post-dequantization threshold value.

In Formula (1), C is a first fixed value. The first fixed value is, for example, zero or a minimum value Y_min in the second data type. For example, the minimum value of the 8-bit integer type is −128. The first fixed value is preferably determined as a value obtained by inputting the post-dequantization threshold value Th to the quantization function dq\hat{ }−1, that is, determined as C=dq\hat{ }−1 (Th).

For example, the dequantization is performed using the entire range (Y_min or more and Y_max or less described above) that can be taken by the value of the second data type. In this case, Y_min which is the minimum value of the second data type is used as the fixed value C in Formula (1).

Specifically, in the quantization represented by Formula (1), the value z of the cell larger than the post-dequantization threshold value Th and equal to or less than Z_max in the third data type is mapped to a range larger than Y_min and equal to or less than Y_max in the second data type by the quantization function. Therefore, in the dequantization, y larger than Y_min and equal to or less than Y_max in the second data type is mapped to a range larger than Th and equal to or less than Z_max in the third data type. That is, the range of [y_min<y<=Y_max] is mapped to the range of [Th<z<=Z_max].

Also, in the quantization, the value of the cell which is equal to or larger than Z_min and equal to or less than Th in the third data type is mapped to the minimum value Y_min in the second data type. Therefore, when dequantization is performed on y=y_min, z=Th is obtained.

Here, as will be described later, the post-dequantization threshold value Th is preferably determined as a boundary value between an important value and an unimportant value in the processing after dequantization. When Th is set in this manner, the range [z<=Th] of the third data type that is not important after the dequantization is mapped to one fixed value C (for example, Y_min) in the second data type. Thus, a broad range in the second data type (for example, a range of Y_min or more and Y_max or less which is the entire possible numerical range of the second data type) can be dequantized to the third data type by using the inverse function dq of the quantization function.

Note that, in the example of FIG. 1, the existence probability map 80 is the target map. Therefore, dequantization is performed on the existence probability map 80. Hereinafter, the existence probability map 80 in which the value of each cell is dequantized is referred to also as a dequantization existence probability map 82.

Before executing the dequantization processing on the target map, the image processing device 2000 determines whether the value of each cell of the target map matches the first fixed value. Then, the image processing device 2000 performs dequantization processing on each cell of the target map based on the determination result. For example, the cell of the target map whose value is the fixed value C is excluded from the target of the dequantization using the dequantization function. This can reduce the cost required for the dequantization processing.

Hereinafter, processing of determining whether the value of the cell is the first fixed value is referred to also as matching determination processing.

Hereinafter, the image processing device 2000 of the present embodiment will be described in more detail.

### <Example of Functional Configuration>

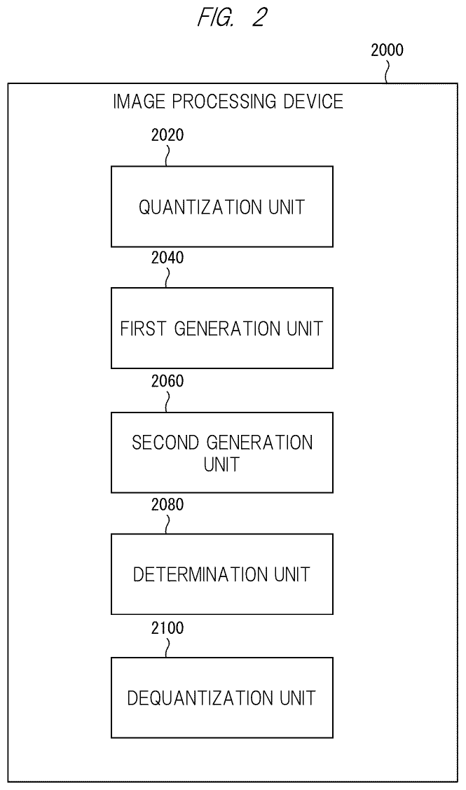

FIG. 2 is a block diagram illustrating a functional configuration of the image processing device 2000. The image processing device 2000 includes a quantization unit 2020, a first generation unit 2040, a second generation unit 2060, a determination unit 2080, and a dequantization unit 2100. The quantization unit 2020 quantizes the image 10 to generate the quantized image 12. The first generation unit 2040 generates the feature map 20 based on the quantized image 12. The second generation unit 2060 generates the existence probability map 80 by using the feature map 20. The determination unit 2080 determines whether the value of each cell of the target map that is a target of the dequantization processing matches the first fixed value. The dequantization unit 2100 executes dequantization processing for each cell of the target map based on the determination result by the determination unit 2080.

### <Example of Hardware Configuration>

For example, each functional configuration unit of the image processing device 2000 is implemented by hardware (for example, hardwired electronic circuits or the like) that implements each functional configuration unit. In addition, for example, each functional configuration unit of the image processing device 2000 is implemented by a combination of hardware and software (for example, a combination of electronic circuits and a program for controlling the electronic circuits).

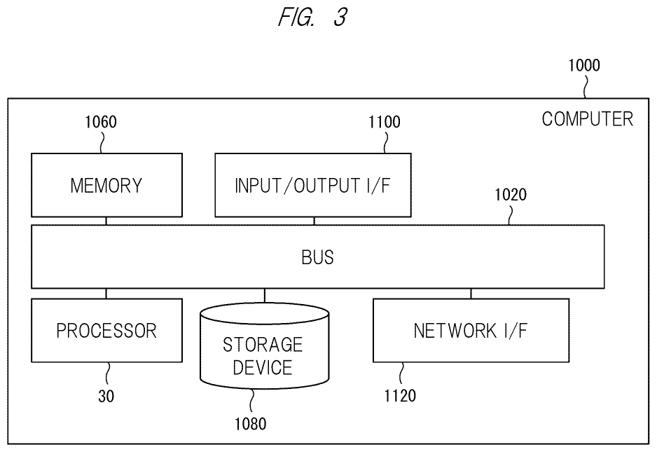

FIG. 3 is a block diagram illustrating a hardware configuration of a computer 1000 that implements the image processing device 2000. The computer 1000 may be any computer. For example, the computer 1000 is an integrated circuit such as a system on chip (SoC). In addition, for example, the computer 1000 is a stationary computer such as a personal computer (PC) or a server machine. In addition, for example, the computer 1000 is a portable computer such as a smartphone or a tablet terminal. The computer 1000 may be a dedicated computer designed to implement the image processing device 2000, or may be a general-purpose computer.

For example, by installing a predetermined application in the computer 1000, each function of the image processing device 2000 is implemented in the computer 1000. The above application is configured by a program for implementing each functional configuration unit of the image processing device 2000. Note that any method can be used to acquire the program. For example, the program can be acquired from a storage medium (a digital versatile disc (DVD), a universal serial bus (USB) memory, and the like) in which the program is stored. In addition, for example, the program can be acquired by downloading the program from a server device that manages the storage device in which the program is stored.

The computer 1000 includes a processor 1040, a bus 1020, a memory 1060, a storage device 1080, an input/output interface (I/F) 1100, and a network interface 1120. The bus 1020 is a data transmission path through which the processor 1040, the memory 1060, the storage device 1080, the input/output interface 1100, and the network interface 1120 transmit and receive data to and from each other. However, the method of connecting the processor 1040 and the like to each other is not limited to the bus connection.

The processor 1040 may be any of various processors such as a micro processing unit (MPU), a central processing unit (CPU), a graphics processing unit (GPU), a digital signal processor (DSP), and a field-programmable gate array (FPGA). The memory 1060 is a main storage device implemented using a random access memory (RAM) or the like. The storage device 1080 is an auxiliary storage device implemented using a read only memory (ROM), a flash memory, a memory card, or the like. The input/output interface 1100 is an interface for connecting the computer 1000 and an input/output device. The network interface 1120 is an interface for connecting the computer 1000 to the network.

The storage device 1080 stores a program for implementing each functional configuration unit of the image processing device 2000 (a program for implementing the above-described application) The processor 1040 loads the program stored in the storage device 1080 into the memory 1060 and executes the program to implement each functional configuration unit of the image processing device 2000.

The image processing device 2000 may be implemented by one computer 1000 or may be implemented by a plurality of computers 1000. In the latter case, the configurations of the computers 1000 do not need to be the same, and can be different from each other.

### <Configuration of Neural Network 60>

Here, some specific configurations of the neural network 60 will be exemplified. Note that the neural network 60 described here does not include matching determination processing and dequantization processing. The neural network 60 including the matching determination processing and the dequantization processing will be described later.

### Example 1

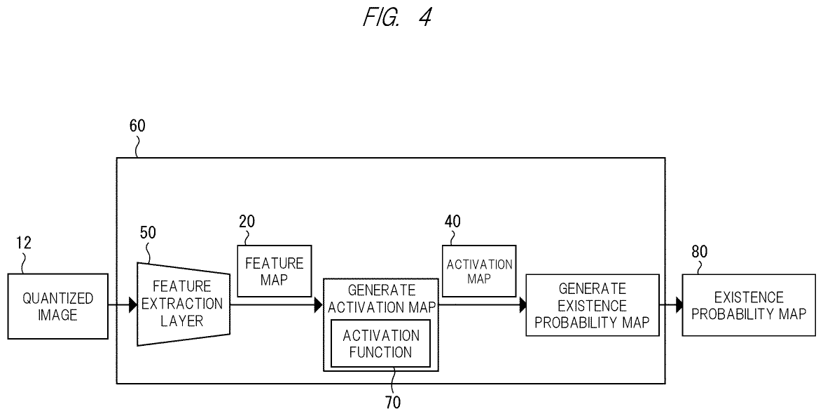

FIG. 4 is a first diagram illustrating a configuration of the neural network 60. In FIG. 4, the neural network 60 includes a feature extraction layer 50 and an activation function 70. The activation function 70 is an activation function applied to each cell constituting the feature map 20. The activation function may be of any type.

The first generation unit 2040 inputs the quantized image 12 to the feature extraction layer 50. The feature extraction layer 50 outputs the feature map 20 in response to the input of the quantized image 12.

The second generation unit 2060 generates the existence probability map 80 from the feature map 20. For this purpose, for example, the second generation unit 2060 generates an activation map 40 from the feature map 20 by using the activation function 70. Each cell of the activation map 40 indicates an activation value of a cell of the feature map 20 corresponding to the cell of the activation map 40. The activation value of the cell of the feature map 20 is obtained from the activation function 70 by inputting the value of the cell to the activation function 70.

Further, the second generation unit 2060 generates the existence probability map 80 based on the activation map 40. For example, the second generation unit 2060 uses the activation map 40 directly as the existence probability map 80.

Here, the image processing device 2000 may generate the existence probability map 80 for each of multiple types (hereinafter, referred to also as class) of objects. For example, it is assumed that the image 10 is an image obtained from a camera mounted on a vehicle. In this case, the image processing device 2000 can be used to detect objects of various classes such as a person, a vehicle, a building, and a guardrail.

In a case where the existence probability map 80 is generated for each of the multiple types of objects, for example, the neural network 60 includes the feature extraction layer 50 for each type of object. Specifically, the neural network 60 includes the feature extraction layer 50 used to generate the existence probability map 80 indicating the existence probability of a person, the feature extraction layer 50 used to generate the existence probability map 80 indicating the existence probability of a vehicle, and the like.

### Example 2

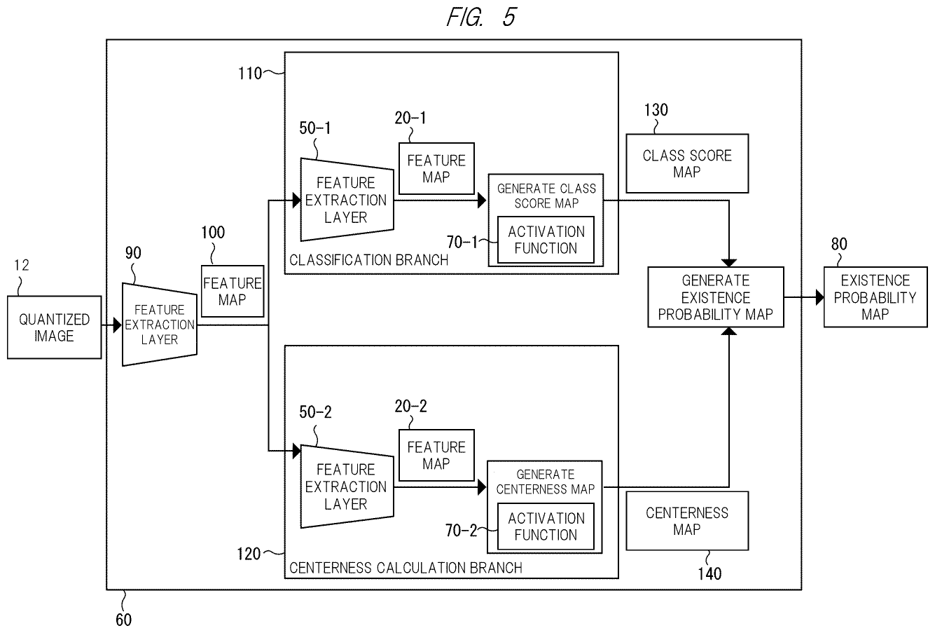

FIG. 5 is a second diagram illustrating a configuration of the neural network 60. In the example of FIG. 5, the neural network 60 is a fully convolutional one-stage object detection (FCOS)-based neural network.

The neural network 60 of FIG. 5 includes a feature extraction layer 90, a classification branch 110, and a centerness calculation branch 120.

The quantized image 12 output from the quantization unit 2020 is input to the feature extraction layer 90. The feature extraction layer 90 outputs a feature map 100 in response to the input of the quantized image 12. The feature map 100 is input to both the classification branch 110 and the centerness calculation branch 120. Therefore, it can be said that the feature map 100 represents distribution of the feature amounts obtained from the quantized image 12 useful for both the task realized by the classification branch 110 and the task realized by the centerness calculation branch 120.

In the classification branch 110, a class score map 130 is output in response to the input of the feature map 100. The class score map 130 indicates spatial distribution of class scores. The class score represents the probability that an object of a particular class exists in an image region of the image 10 corresponding to each cell of the feature map 100.

More specifically, in the classification branch 110, when the first generation unit 2040 inputs the feature map 100 to a feature extraction layer 50-1, a feature map 20-1 is output from the feature extraction layer 50-1. The feature extraction layer 50-1 is one of the plurality of feature extraction layers 50 included in the neural network 60. The feature map 20-1 is one of the plurality of feature maps 20 generated by the neural network 60.

The second generation unit 2060 generates the class score map 130 from the feature map 20-1. The class score map 130 is an activation map obtained from the feature map 20-1. Then, the second generation unit 2060 generates the class score map 130 by calculating the activation value of each cell of the feature map 20-1 by using an activation function 70-1. The activation function 70-1 is one of the plurality of activation functions 70 included in the neural network 60.

In the centerness calculation branch 120, a centerness map 140 is output in response to the input of the feature map 100. The centerness map 140 indicates a centerness value for each cell. The centerness map 140 indicates how close the image region of the image 10 corresponding to each cell of the feature map 100 is to the center of the object.

More specifically, in the centerness calculation branch 120, when the first generation unit 2040 inputs the feature map 100 to a feature extraction layer 50-2, a feature map 20-2 is output from the feature extraction layer 50-2. The feature extraction layer 50-2 is one of the plurality of feature extraction layers 50 included in the neural network 60. The feature map 20-2 is one of the plurality of feature maps 20 generated by the neural network 60.

The second generation unit 2060 generates a centerness map 140 from the feature map 20-2. The centerness map 140 is an activation map obtained from the feature map 20-2. Then, the second generation unit 2060 generates the centerness map 140 by calculating the activation value of each cell of the feature map 20-2 by using an activation function 70-2. The activation function 70-2 is one of the plurality of activation functions 70 included in the neural network 60.

Further, the second generation unit 2060 generates the existence probability map 80 by using the class score map 130 and the centerness map 140. For example, the second generation unit 2060 generates the existence probability map 80 by calculating a cell-wise product between the class score map 130 and the centerness map 140.

The operation of calculating the cell-wise product between the two maps means an operation of calculating the product between cells at the same positions. For example, in the existence probability map 80, the value of the cell at the position (i, j) indicates the product of the value of the cell at the position (i, j) in the class score map 130 and the value of the cell at the position (i, j) in the centerness map 140.

As described above, the image processing device 2000 may generate the existence probability map 80 for each of the plurality of classes. In a case where the existence probability map 80 is generated for each of the plurality of classes, the neural network 60 generates the class score map 130 for each class. For this purpose, the feature extraction layer 50-1 is prepared for each class. For each class, the second generation unit 2060 generates the existence probability map 80 for the class by calculating the cell-wise product between the class score map 130 generated for the class and the centerness map 140.

### <Procedure of Processing>

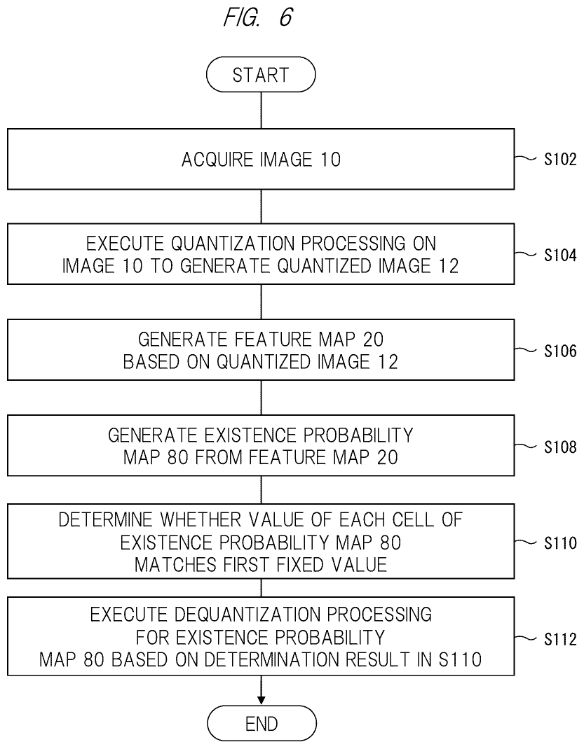

FIG. 6 is a first flowchart illustrating a procedure of processing executed by the image processing device 2000. In the example of FIG. 6, the existence probability map 80 is treated as a target map.

The quantization unit 2020 acquires the image 10 (S102). The quantization unit 2020 executes quantization processing on the image 10 to generate the quantized image 12 (S104). The first generation unit 2040 generates the feature map 20 based on the quantized image 12 (S106). The second generation unit 2060 generates the existence probability map 80 from the feature map 20 (S108). The determination unit 2080 determines whether the value of each cell of the existence probability map 80 matches the first fixed value (S110). The dequantization unit 2100 executes dequantization processing for each cell of the existence probability map 80 based on the determination result in S110 (S112).

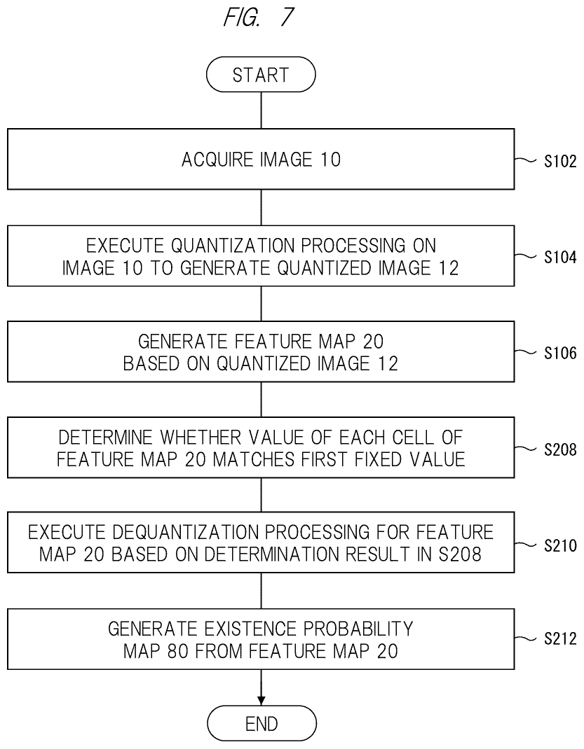

FIG. 7 is a second flowchart illustrating a procedure of processing executed by the image processing device 2000. In the example of FIG. 7, the feature map 20 is treated as a target map. Note that steps S102 to S106 are common in FIG. 6 and FIG. 7. Therefore, in the following, the flowchart of FIG. 7 will be described from the process after step S106.

The determination unit 2080 determines whether the value of each cell of the feature map 20 matches the first fixed value (S208). The dequantization unit 2100 executes dequantization processing for each cell of the feature map 20 based on the determination result in S208 (S210). The second generation unit 2060 generates the existence probability map 80 by using the dequantized feature map 20 (S212).

### <Acquisition of Image 10: S102>

The quantization unit 2020 acquires the image 10 (S102). Various methods can be adopted as a method of acquiring an image to be processed. For example, the image 10 is stored in a storage unit accessible from the image processing device 2000. The quantization unit 2020 acquires the image 10 stored in the storage unit.

For example, a user of the image processing device 2000 designates an image to be treated as the image 10 by designating a file name or the like. The quantization unit 2020 acquires the image designated by the user from the storage unit as the image 10.

In addition, for example, the image 10 is transmitted from a device other than the image processing device 2000 to the image processing device 2000. In this case, the quantization unit 2020 receives an image transmitted from another device and handles the image as the image 10.

Any device can transmit the image 10 to the image processing device 2000. For example, the device is a camera that has generated the image 10. In this case, for example, the image processing device 2000 generates the existence probability map 80 for the image 10 generated by the camera. For example, in a case where a camera is provided in a vehicle, a situation around the vehicle is captured in the image 10. Therefore, by generating the existence probability map 80 from the image 10 by using the image processing device 2000, it is possible to grasp the distribution of the existence probability of the object around the vehicle.

### <Quantization Processing: S104>

The quantization unit 2020 executes quantization processing on the image 10 to generate the quantized image 12 (S104). There are various specific methods of quantization. For example, the quantization unit 2020 quantizes the value of each pixel of the image 10 according to the following Formula (2).

$$[ Math . 2 ]$$

$$y = \{ \begin{matrix}Ya & ( q ( x ) \leq Ya ) \\ q ( x ) & ( Ya < q ( x ) < Yb ) \\ Yb & ( q ( x ) \geq Yb )\end{matrix} \qquad ( 2 )$$

$$q ( x ) = \frac{x}{s} + u$$

Here, q(x) represents a quantization function. Both s and u represent predetermined parameters used for quantization. Ya represents the minimum value of the value of y in the quantization (that is, the minimum value that can be taken by the pixel value of the quantized image 12). Also, Yb represents the maximum value of the value of y in the quantization (that is, the maximum value that can be taken by the pixel value of the quantized image 12).

It can also be said that the above-described quantization processing is processing of mapping the value of the pixel of the image 10 to a numerical range of Ya or more and Yb or less. For example, Ya and Yb are set to a minimum value Y_min and a maximum value Y_max that can be taken by the value of the second data type, respectively.

### <Generation of Feature Map 20: S106>

The first generation unit 2040 generates the feature map 20 based on the quantized image 12 by using the feature extraction layer 50 (S106). As described above, for example, the feature extraction layer 50 is configured to generate the feature map 20 in response to an input of an image (see FIG. 4). In this case, the first generation unit 2040 obtains the feature map 20 from the feature extraction layer 50 by inputting the quantized image 12 to the feature extraction layer 50.

In addition, for example, the feature extraction layer 50 is configured to generate the feature map 20 in response to an input of a feature map other than the feature map 20 (see FIG. 5). In this case, the first generation unit 2040 obtains the feature map 20 by inputting a feature map generated from the quantized image 12 to the feature extraction layer 50.

As illustrated in FIG. 6 and FIG. 7, the procedure of processing executed after generation of the feature map 20 is different between the case where the existence probability map 80 is treated as a target map and the case where the feature map 20 is treated as a target map. First, the case where the existence probability map 80 is treated as a target map will be described.

Thereafter, the case where the feature map 20 is treated as a target map will be described.

<Case where Existence Probability Map 80 is Treated as Target Map>

### <<Generation of Existence Probability Map 80: S108>>

The second generation unit 2060 generates the existence probability map 80 from the feature map 20 (S108). For example, as in the example described with reference to FIG. 4, the second generation unit 2060 generates the activation map 40 from the feature map 20, and generates the existence probability map 80 from the activation map 40. In addition, for example, as in the example described with reference to FIG. 5, the second generation unit 2060 generates a plurality of activation maps 40 from the feature map 20, and generates the existence probability map 80 based on the plurality of generated activation maps 40.

### <<Determination Processing: S110>>

The determination unit 2080 determines whether the value of each cell of the existence probability map 80 matches the first fixed value (S110). For example, the determination unit 2080 sequentially compares the value of each cell of the existence probability map 80 with the first fixed value C (for example, Y_min) in the second data type before dequantization. In addition, for example, the determination unit 2080 may perform the comparison of the values of the plurality of cells with the first fixed value C (for example, Y_min) in parallel. For the parallel comparison processing, for example, a single instruction multiple data (SIMD) instruction can be used.

For example, an integer type and a floating point type are used as the second data type and the third data type, respectively. Comparing values in the second data type that is an integer type before dequantization has an advantage that a processing speed and power efficiency can be improved as compared with a case where values are compared in the third data type that is a floating point type after dequantization.

### <<Dequantization Processing: S110>>

The dequantization unit 2100 performs dequantization processing for each cell of the existence probability map 80 based on the result of the determination (that is, matching determination processing) performed in S110 (S112). Specifically, the dequantization unit 2100 performs the dequantization processing by using a dequantization function z=dq(y) that is an inverse function of the quantization function y=dq\hat{ }−1(z) of Formula (1).

For example, the image processing device 2000 performs the matching determination processing on all the cells of the existence probability map 80 and then performs the dequantization processing. In addition, for example, the image processing device 2000 sequentially performs processing of “performing matching determination processing and performing dequantization processing based on the result of determination” for each cell of the existence probability map 80.

In addition, for example, the image processing device 2000 may divide the cells of the existence probability map 80 into groups having a predetermined number of cells and perform processing for each group. That is, the image processing device 2000 sequentially performs processing of “performing matching determination processing for each cell included in group and performing dequantization processing based on the result of determination” for a plurality of groups.

The size of the group is preferably set such that all the cells included in one group can be processed in parallel. For example, in a case where a single instruction multiple data (SIMD) instruction is implemented in the processor 1040, the size of the group is set to the number of pieces of data that can be handled at a time by the SIMD instruction.

For example, the dequantization unit 2100 excludes the cell of the existence probability map 80 whose value is the first fixed value from the target of the dequantization using the dequantization function. In other words, the dequantization unit 2100 performs dequantization using the dequantization function only for cells whose values are not the first fixed value.

Here, the dequantization existence probability map 82 is generated based on the result of the dequantization processing by the dequantization unit 2100. For example, an initial value such as a post-dequantization threshold value Th is set as an initial value for each cell of the dequantization existence probability map 82. After generating the dequantization existence probability map 82 in which the initial value is set, the dequantization unit 2100 sets the value calculated using the dequantization function (that is, z=dq(y)) to the corresponding cell of the dequantization existence probability map 82. In this way, an initial value such as the post-dequantization threshold value Th remains set for the cell of the dequantization existence probability map 82 corresponding to the cell of the existence probability map 80 excluded from the target of the dequantization using the dequantization function. As a result, each cell of the existence probability map 80 whose value is the first fixed value is dequantized to a common fixed value which is the initial value.

For example, it is assumed that an initial value Th is set for each cell of the dequantization existence probability map 82. Further, in the existence probability map 80, it is assumed that the value y[i1, j1] of the cell at the position (i1, j1) is not the first fixed value. In this case, dq(y[i1, j1]) is set for the cell at the position (i1, j1) of the dequantization existence probability map 82. On the other hand, in the existence probability map 80, it is assumed that the value y[i2,j2] of the cell at the position (i2,j2) is the first fixed value. In this case, the cell at the position (i2, j2) of the dequantization existence probability map 82 remains at the initial value Th.

The dequantization unit 2100 does not necessarily generate the dequantization existence probability map 82. For example, the dequantization unit 2100 generates, for each cell of the existence probability map 80 whose value is not the first fixed value, a tuple (i, j, z[i, j]) representing a combination of the position (i, j) of the cell and the value z[i, j] obtained by dequantizing the value y[i, j] of the cell.

Here, how determination is made in the dequantization processing will be described in more detail. For example, the quantization function dq in Formula (1) that defines the quantization processing is determined such that the numerical range of “equal to or larger than the post-dequantization threshold value Th and equal to or less than the observation maximum value of cell of existence probability map 80” after the dequantization is mapped to the numerical range of “equal to or larger than Y_min and equal to or less than Y_max” that can be taken by the value before the dequantization (that is, the value of the second data type). The observation maximum value of the cell of the existence probability map 80 is the maximum value of the value that is predicted to be actually indicated in the cell of the existence probability map 80. The dequantization processing is determined as inverse processing of the quantization processing determined in this manner.

The observation maximum value of the cell of the existence probability map 80 is determined by, for example, prior calibration. In the prior calibration, the existence probability map 80 is generated for each of the plurality of images 10. Then, the observation maximum value is determined using a set of cell values obtained from the plurality of generated existence probability maps 80.

For example, the maximum value included in the set of cell values is used as the observation maximum value. In addition, for example, a value obtained by adding a predetermined margin to the maximum value included in the set of cell values is used as the observation maximum value. Note that the calibration is preferably performed such that the observation maximum value of the cell of the existence probability map 80 is Y_max, which is the maximum value of the third data type.

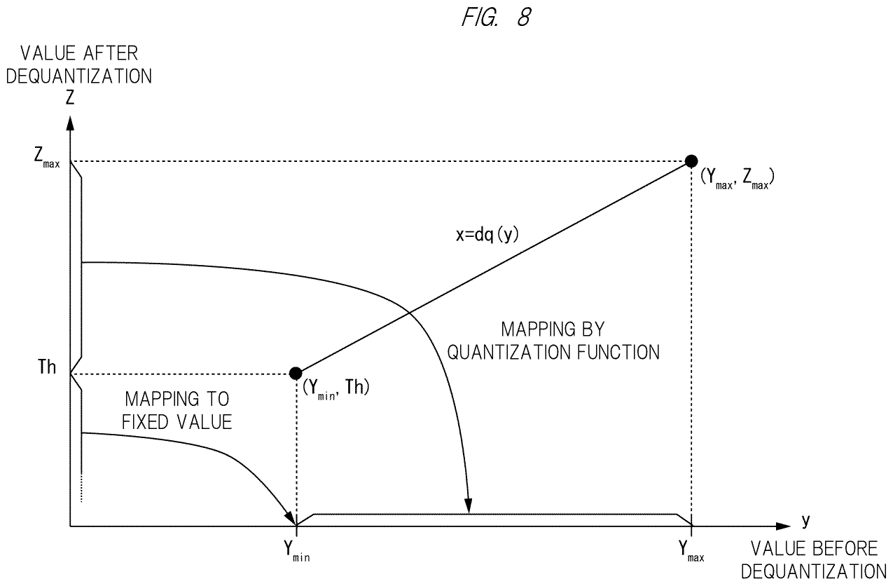

FIG. 8 is a diagram illustrating a dequantization function determined based on the post-dequantization threshold value and the observation maximum value. First, in the quantization processing, the quantization function y=dq\hat{ }−1(z) is determined such that the numerical range of z of [Th<z<=Z_max] is mapped to the numerical range of Y of [Y_min<y<=Y_max]. Further, in the quantization processing, the numerical range of z of [Th<z] is determined so as to be mapped to y=Ymin. Therefore, the dequantization function z=dq(y) is determined such that the numerical range of y of [Y_min<=y<=Y_max] is mapped to the numerical range of z of [Th<=z<=Z_max]. As a more specific example, the dequantization function is defined as a function representing a straight line passing through two points (Y_min, Th) and (Y_max, Z_max).

Here, the quantization that “all the values equal to or less than Th are converted into Y_min” also has an advantage that the processing speed can be increased. For example, it is assumed that the existence probability map 80 is generated for each of the plurality of classes. In this case, for each of the plurality of regions of the image 10, a vector indicating the existence probability of the object of each class (hereinafter, the existence probability vector) is obtained.

For example, it is assumed that the existence probability map 80 is generated for each of the three types of classes C1, C2, and C3. In this case, an existence probability vector (L1[i, j], L2[i, j], L3[i, j]) in which the existence probability L1[i, j] of the object of the class C1, the existence probability L2[i, j] of the object of the class C2, and the existence probability L3[i, j] of the object of the class C3 are listed for each position (i, j) is obtained.

With respect to the image 10, it is assumed that processing related to an object is performed using the dequantization existence probability map 82 obtained by dequantizing the existence probability map 80. In the processing, a region where no object exists can be ignored. Therefore, it is preferable that a region where no object exists can be easily specified.

Here, it is assumed that a region where no object exists is specified based on a determination criterion of “when a value of a cell of the dequantization existence probability map 82 is equal to or less than a predetermined probability threshold value, there is no object in the cell”. In this case, the probability threshold value is used as the post-dequantization threshold value Th. By using the probability threshold value as the post-dequantization threshold value, all the elements of the existence probability vector obtained for the region where no object exists indicate Y_min. Therefore, by detecting the existence probability vector in which all the elements are Y_min, the region where no object exists can be easily specified even before the dequantization processing is performed on the existence probability map 80. Therefore, it is possible to speed up the processing by, for example, performing dequantization using a dequantization function only for the cell indicating the region where an object exists.

The existence probability vector in which all the elements are Y_min can be easily and quickly detected by, for example, parallel comparison processing using the SIMD instruction. For example, the SIMD instruction of “determining in parallel whether values at the same positions coincide with each other” is executed for a vector in which all the elements are set to Y_min and the existence probability vector. By the parallel comparison processing, it is possible to easily and quickly determine whether all the elements of the existence probability vector are Y_min.

Here, there is a processor having a characteristic that the cost of the matching determination processing which is a determination as to whether two values match is lower than the cost of the size comparison processing to determine whether one value is larger than the other value. In such a processor, the cost of the matching determination processing to determine “whether the value of the cell matches Y_min” is smaller than the cost of the size comparison processing to determine “whether the value of the cell is equal to or less than Y_min”. Therefore, according to the image processing device 2000 in which the dequantization processing is designed such that the value of the cell that can be excluded from the processing target is mapped to one fixed value, the cell that can be excluded from the processing target can be detected at low cost.

### <<Determination Method of Post-Dequantization Threshold Value>>

When the dequantization function is determined as the inverse function of the quantization function determined as described above, the value of the cell having the minimum value Y_min in the existence probability map 80 is dequantized to the post-dequantization threshold value Th. Therefore, a value less than Th does not appear in the value after the dequantization. Therefore, the post-dequantization threshold value Th is preferably determined as a boundary value between “relatively small values that do not need to consider the difference between each other” and “relatively large values that need to consider the difference between each other”. In other words, the post-dequantization threshold value is preferably defined as a boundary value between a relatively unimportant value and a relatively important value. In this way, all the relatively unimportant values after the dequantization are aggregated into one value of Y_min before dequantization. Therefore, the relatively unimportant value appearing after the dequantization is only the post-dequantization threshold value Th.

The post-dequantization threshold value Th can be specifically determined in various ways. For example, the post-dequantization threshold value is manually determined by an administrator or a user of the image processing device 2000.

In addition, for example, the post-dequantization threshold value may be determined on the assumption of a use scene of the existence probability map 80. For example, as described above, the probability threshold value serving as a criterion for determining whether an object exists in the region is used as the post-dequantization threshold value.

For example, it is assumed that the activation map 40 is directly used as the existence probability map 80. Also, it is assumed that the probability threshold value is set to 0.8. In this case, in the existence probability map 80, an image region of the image 10 corresponding to the cell having the value of 0.8 or more is treated as the image region where an object exists. Therefore, a value of 0.8 which is the same as the probability threshold value is used as the post-dequantization threshold value.

In a case where the dequantization existence probability map 82 is used for detecting an object, an importance level of the cell having a value larger than the probability threshold value is higher than an importance level of the cell having a value equal to or less than the probability threshold value in the dequantization existence probability map 82. Since the value of the cell larger than the probability threshold value has relatively high importance level, it is preferably calculated using a dequantization function. On the other hand, since the value of the cell equal to or less than the probability threshold value has relatively low importance level, it is presumed that there is no problem in detecting the object even when the value is converted into the fixed value Th. Furthermore, as described above, the cell equal to or less than the probability threshold value may be excluded from the processing target. Therefore, the probability threshold value can be used as the post-dequantization threshold value Th.

<Case where Feature Map 20 is Treated as Target Map>

In a case where the feature map 20 is treated as a target map, dequantization processing is performed on the feature map 20. Here, in a case where dequantization is performed on the feature map 20, matching determination processing and dequantization processing are performed in the neural network 60. Therefore, first, the configuration of the neural network 60 in a case where the feature map 20 is the target map will be described more specifically.

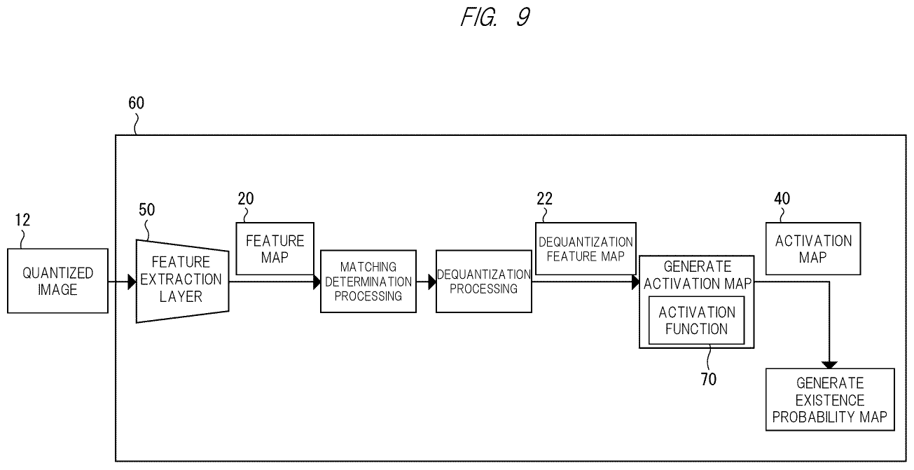

FIG. 9 illustrates a more specific configuration of the neural network 60 illustrated in FIG. 4 for the case where the feature map 20 is treated as the target map. In the neural network 60 of FIG. 9, matching determination processing is performed by the determination unit 2080 on the feature map 20 output from the feature extraction layer 50. Furthermore, based on the result of the matching determination processing, the dequantization unit 2100 performs dequantization processing on the feature map 20. As a result, a dequantization feature map 22 is generated. Each cell of the dequantization feature map 22 is obtained by dequantizing the corresponding cell of the feature map 20 by the dequantization unit 2100.

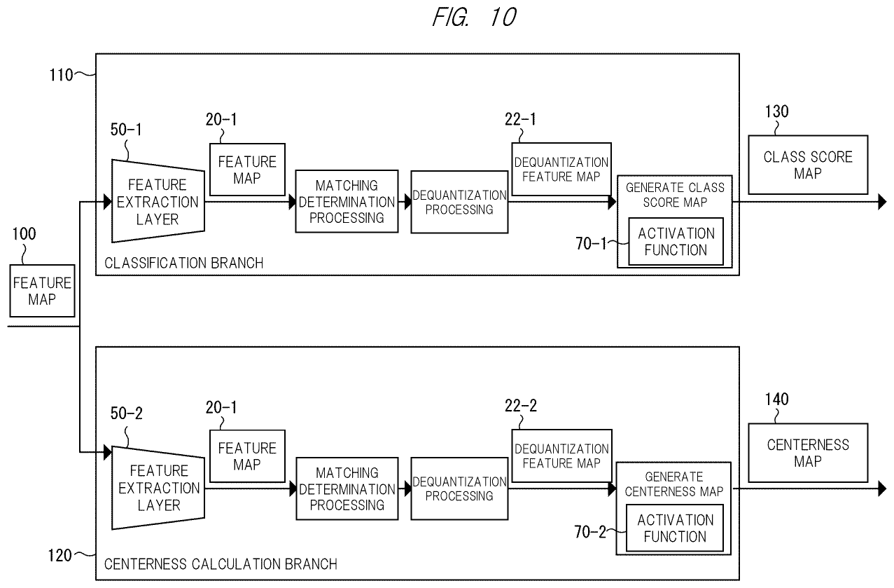

FIG. 10 illustrates a more specific configuration of the neural network 60 illustrated in FIG. 5 for the case where the feature map 20 is treated as the target map. Note that, in FIG. 10, components other than the classification branch 110 and the centerness calculation branch 120 are omitted.

In the neural network 60 of FIG. 10, matching determination processing is performed by the determination unit 2080 on the feature map 20-1 output from the feature extraction layer 50-1. Furthermore, based on the result of the matching determination processing, the dequantization unit 2100 performs dequantization processing on the feature map 20-1. As a result, a dequantization feature map 22-1 is generated. Each cell of the dequantization feature map 22-1 is obtained by dequantizing the corresponding cell of the feature map 20-1 by the dequantization unit 2100. However, the cell of the feature map 20-1 whose value is the first fixed value can be excluded from the target of the dequantization using the dequantization function.

Similarly, matching determination processing is performed by the determination unit 2080 on the feature map 20-2 output from the feature extraction layer 50-2. Furthermore, based on the result of the matching determination processing, the dequantization unit 2100 performs dequantization processing on the feature map 20-2. As a result, a dequantization feature map 22-2 is generated. Each cell of the dequantization feature map 22-2 is obtained by dequantizing the corresponding cell of the feature map 20-2 by the dequantization unit 2100. However, the cell of the feature map 20-2 whose value is the first fixed value can be excluded from the target of the dequantization using the dequantization function.

### <<Matching Determination Processing: S208>>

The determination unit 2080 determines whether the value of each cell of the feature map 20 matches the first fixed value (S208). As described above, the determination unit 2080 may sequentially compare the value of each cell of the feature map 20 of the second data type before dequantization with the first fixed value C (for example, Y_min), or may perform the comparison of the values of the plurality of cells with the first fixed value C (for example, Y_min) in parallel. Comparing values in the second data type that is an integer type before dequantization has an advantage that a processing speed and power efficiency can be improved as compared with a case where values are compared in the third data type that is a floating point type after dequantization.

### <<<Example of Determination Method of Post-Dequantization Threshold Value Th>>>

The post-dequantization threshold value Th can be determined in various ways. For example, the post-dequantization threshold value Th is manually determined by the administrator or the user of the image processing device 2000. In addition, for example, as described below, the post-dequantization threshold value Th may be determined in consideration of a use scene of the dequantized feature map 20 (dequantization feature map 22).

In a case where the feature map 20 is treated as the target map, the dequantization feature map 22 is generated from the feature map 20. Then, the activation map 40 is generated by calculating the activation value for each cell of the dequantization feature map 22.

Therefore, for example, the post-dequantization threshold value Th is determined such that the activation value obtained from the dequantization feature map 22 becomes relatively large to some extent. Specifically, first, a post-activation threshold value Ta is determined for the activation value obtained using the activation function 70. For example, the probability threshold value described above is used as the post-activation threshold value.

The post-dequantization threshold value Th is determined such that a value obtained by inputting the post-dequantization threshold value Th to the activation function 70 matches the post-activation threshold value. Therefore, the post-dequantization threshold value Th is calculated by inputting the post-activation threshold value to the inverse function of the activation function 70. For example, in a case where the activation function 70 is a sigmoid function, the inverse function is a logit function.

Specifically, the post-dequantization threshold value Th is calculated as follows using the post-activation threshold value Ta.

$$[ Math . 3 ]$$

$$Th = {f}^{- 1} ( Ta ) \qquad ( 3 )$$

Here, f\hat{ }−1( ) represents an inverse function of the activation function 70. Therefore, f( ) represents the activation function 70.

Note that the first fixed value C can be determined using the post-dequantization threshold value Th determined in this manner. Specifically, the first fixed value C is determined as C=dq\hat{ }−1(Th) by using y=dq\hat{ }−1(z) that is an inverse function of the dequantization function z=dq(y) used by the dequantization unit 2100.

Here, a function having no inverse function may also be used as the activation function 70. In this case, the inverse function f−1( ) is defined by extracting, from the activation function 70, a range in which the inverse function can be defined and the post-activation threshold value is included in the value range. Then, the post-dequantization threshold value is calculated from the post-activation threshold value by using the inverse function f−1( ).

Note that, as illustrated in FIG. 10, it is assumed that the class score map 130 and the centerness map 140 are generated as the activation map 40. That is, it is assumed that the feature map 20-1 used to calculate the class score and the feature map 20-2 used to calculate the centerness are generated as the feature map 20. In this case, the fixed value used for the dequantization of the feature map 20-1 and the fixed value used for the dequantization of the feature map 20-2 are preferably set to the same value, and the same value is more preferably the minimum value X_min of the second data type.

### <<Dequantization Processing: S210>>

The dequantization unit 2100 performs dequantization processing for each cell of the feature map 20 based on the determination result in S208 (S210). The method of performing dequantization on the feature map 20 in S210 is, for example, similar to the method of performing dequantization on the existence probability map 80 in S112. That is, the dequantization unit 2100 excludes the cell of the feature map 20 whose value is the first fixed value from the target of the dequantization using the dequantization function. Then, the dequantization unit 2100 performs dequantization using the dequantization function for each cell of the feature map 20 whose value is not the first fixed value.

For example, the dequantization unit 2100 initializes the dequantization feature map 22 in the same manner as the dequantization existence probability map 82. That is, the dequantization unit 2100 generates the dequantization feature map 22 in which an initial value such as the post-dequantization threshold value Th is set for each cell. Then, the dequantization unit 2100 performs dequantization using a dequantization function for each cell of the feature map 20 whose value is not the first fixed value, and sets the value obtained by the dequantization to the corresponding cell of the dequantization feature map 22.

In this case, the initial value remains set in the cell of the dequantization feature map 22 corresponding to the cell of the feature map 20 whose value is the first fixed value.

### <<Generation of Existence Probability Map 80: S212>>

The second generation unit 2060 generates the existence probability map 80 by using the dequantization feature map 22 (S212). For example, the second generation unit 2060 inputs a value of each cell of the dequantization feature map 22 to the activation function 70 to obtain an activation value for each cell of the dequantization feature map 22. Further, the second generation unit 2060 generates the activation map 40 indicating the activation value obtained for each cell of the dequantization feature map 22. Then, the second generation unit 2060 generates the existence probability map 80 based on the activation map 40.

Note that, in a case where the existence probability map 80 is generated from the dequantization feature map 22, a value indicated by each cell of the existence probability map 80 is a dequantized value (a value of the third data type). Therefore, the existence probability map 80 generated in S212 is the dequantized existence probability map 80 (that is, the dequantization feature map 22).

Here, it is assumed that the first fixed value is determined in relation to the activation value. Specifically, it is assumed that the first fixed value is determined by a method of “applying the post-activation threshold value Ta to the inverse function of the activation function 70 to obtain the post-dequantization threshold value Th, and applying the post-dequantization threshold value Th to the quantization function y=dq\hat{ }−1(z) to obtain the first fixed value C=dq\hat{ }−1(Th)”. In this case, it can be said that the importance level of the activation value obtained from the cell whose value is set to the post-dequantization threshold value Th in the dequantization feature map 22 is low.

Therefore, the second generation unit 2060 does not necessarily perform the calculation of the activation value using the activation function 70 for the cell of the dequantization feature map 22 whose value is the post-dequantization threshold value Th. Specifically, the second generation unit 2060 uses a predetermined fixed value (hereinafter, the second fixed value) as the activation value of the cell whose value is the post-dequantization threshold value in the dequantization feature map 22. For example, the post-activation threshold Ta is used as the second fixed value. On the other hand, the second generation unit 2060 calculates the activation value of the cell whose value is not the post-dequantization threshold value in the dequantization feature map 22 by inputting the value of the cell to the activation function 70.

Here, the cell of the dequantization feature map 22 whose value is the post-dequantization threshold value is the cell corresponding to the cell of the feature map 20 whose value is determined to match the first fixed value in the matching determination processing. Therefore, the cell of the dequantization feature map 22 corresponding to the cell of the feature map 20 excluded from the target of the dequantization using the dequantization function can be excluded from the target of the activation using the activation function 70. Note that the value of which cell in the dequantization feature map 22 is the post-dequantization threshold value can be recorded at the time of the dequantization processing.

By generating the activation map 40 by this method, the operation using the activation function 70 is not performed for the cell whose value is the post-dequantization threshold value. Therefore, the calculation cost required for generating the activation map 40 can be reduced.

### <Output of Result>

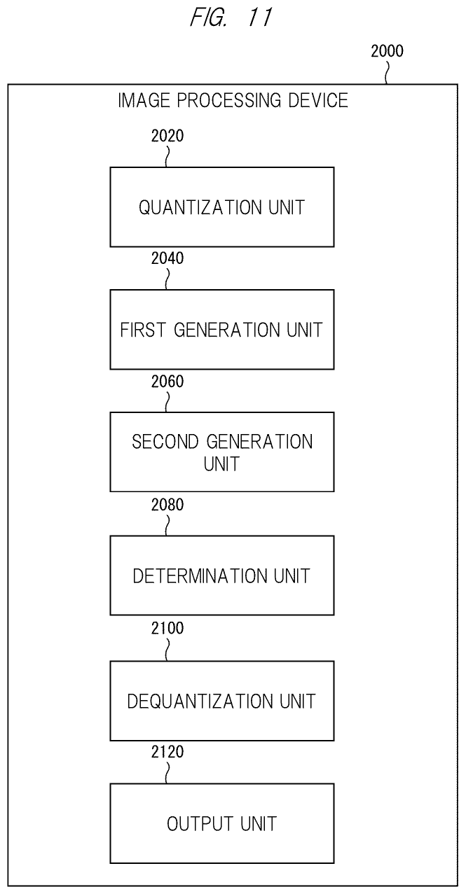

The image processing device 2000 outputs information indicating the processing result (hereinafter, output information). The functional configuration unit that outputs the output information is referred to as an output unit. FIG. 11 is a diagram illustrating a configuration of the image processing device 2000 having the output unit.

Any kind of information may be included in the output information. For example, the output unit 2120 generates output information including the dequantization existence probability map 82. When the existence probability map 80 is generated for each of the plurality of classes, the output information may include the existence probability map 80 for each class. Note that the dequantization existence probability map 82 may be the existence probability map 80 generated from the dequantization feature map 22.

Note that, by using the existence probability map 80 obtained for each class, data (for example, a vector) indicating the existence probability of the object of each class is obtained for each region of the image 10 corresponding to each cell of the existence probability map 80. For example, it is assumed that the existence probability map 80 is generated for each of the three types of classes C1, C2, and C3. In this case, the image processing device 2000 can obtain an existence probability vector (L1[i, j], L2[i, j], L3[i, j]) in which the existence probability L1[i, j] of the object of the class C1, the existence probability L2[i, j] of the object of the class C2, and the existence probability L3[i, j] of the object of the class C3 are listed for each position (i, j).

Any mode may be applied to the output mode of the output information. For example, the output unit 2120 stores the output information in any storage unit. In addition, for example, the output unit 2120 outputs the output information to any display device to cause the display device to display the output information. In addition, for example, the output unit 2120 transmits the output information to another device.

### <Training of Neural Network 60>

The neural network 60 is trained in advance. The training of the neural network 60 is performed using a plurality of training samples. The training sample is, for example, a pair of a training image and a ground-truth map indicating spatial distribution of the existence probability of the object in the training image. The ground-truth map indicates the ideal existence probability map 80 to be output from the neural network 60 in response to the input of the training image.

A device that performs the training of the neural network 60 (hereinafter, the training device) calculates a loss by using the existence probability map 80 obtained by inputting the training image to the neural network 60 and the ground-truth map. Further, the training device updates the trainable parameters (bias, weight between nodes, and the like) included in the neural network 60 by using the calculated loss. The training device trains the neural network 60 by repeating parameter update by using a plurality of training samples.

In the foregoing, the present disclosure has been described with reference to the embodiments, but the present disclosure is not limited to the embodiments described above. Various modifications that can be understood by those skilled in the art can be made to the configuration and details of the present disclosure within the scope of the present disclosure. In addition, each embodiment can be combined with other embodiments as appropriate.

Each drawing is merely an illustration provided for describing one or more embodiments. Each drawing is not necessarily associated with only one particular embodiment, but may be associated with one or more other embodiments. As will be understood by those skilled in the art, various features or steps described with reference to any one of the drawings may be combined with features or steps illustrated in one or more other drawings, for example, in order to produce embodiments that are not explicitly illustrated or described. All of the features or steps illustrated in any one of the drawings for describing embodiments are not necessarily essential, and some features or steps may be omitted. The order of the steps described in any drawing may be changed as appropriate.

In the present disclosure, a program includes a group of instructions (or software code) for causing a computer to execute one or more functions described in the embodiments when the program is loaded into the computer. The program may be stored in a non-transitory computer-readable medium or a tangible storage medium. By way of example and not limitation, the computer-readable medium or tangible storage medium may include random-access memory (RAM), read-only memory (ROM), flash memory, solid-state drive (SSD) or other memory technologies, CD-ROM, digital versatile disc (DVD), Blu-ray (registered trademark) disc or other optical disk storages, magnetic cassette, magnetic tape, magnetic disk storage, or other magnetic storage devices. The program may be transmitted on a transitory computer-readable medium or a communication medium. By way of example and not limitation, the transitory computer-readable medium or communication medium may include propagated signals in electrical, optical, acoustic, or other forms.

### Supplementary Notes

### (Supplementary Note 1)

An image processing device including:
a quantization unit configured to generate a second image by executing quantization processing on a first image;
a first generation unit configured to generate a feature map based on the second image;
a second generation unit configured to generate an existence probability map indicating distribution of existence probability of an object in the first image by using the feature map;
a determination unit configured to perform matching determination processing that is processing of determining whether a value of each cell matches a predetermined fixed value for the feature map or the existence probability map; and
a dequantization unit configured to perform dequantization processing on the feature map or the existence probability map based on a result of the matching determination processing.

### (Supplementary Note 2)

The image processing device according to supplementary note 1,
wherein the dequantization unit is configured to:
when the value of the cell does not match the fixed value, dequantize the value of the cell by using a dequantization function; and
when the value of the cell matches the fixed value, use a predetermined value as a value obtained by dequantizing the value of the cell.

### (Supplementary Note 3)

The image processing device according to supplementary note 2,
wherein the matching determination processing and the dequantization processing are performed on the existence probability map, and
wherein the fixed value is a value obtained by inputting a probability threshold value used for determining whether an object exists to an inverse function of the dequantization function.

### (Supplementary Note 4)

The image processing device according to supplementary note 3,
wherein the inverse function of the dequantization function is defined such that the fixed value is set to a minimum value of possible values of a data type used in the feature map or the existence probability map.

### (Supplementary Note 5)

The image processing device according to supplementary note 1,
wherein the matching determination processing and the dequantization processing are performed on the feature map, and
wherein the second generation unit generates the existence probability map by using the dequantized feature map.

### (Supplementary Note 6)

The image processing device according to supplementary note 3,
wherein the first generation unit generates a first of the feature map and a second of the feature map,
wherein the determination unit performs the matching determination processing on each of the first of the feature map and the second of the feature map,
wherein the dequantization unit performs the dequantization processing on each of the first of the feature map and the second of the feature map, and
wherein the second generation unit is configured to:
generate a class map indicating distribution of existence probability for an object of a particular class by using the first of the feature map;
generate a centerness map indicating distribution of proximity from a center of an object by using the second of the feature map; and
generate the existence probability map for the object of the particular class by using the class map and the centerness map.

### (Supplementary Note 7)

The image processing device according to supplementary note 5,
wherein the second generation unit generates the existence probability map from the dequantized feature map by using an activation function.

### (Supplementary Note 8)

The image processing device according to supplementary note 7,
wherein the fixed value is a value obtained by inputting a value obtained by inputting a probability threshold value used for determining whether an object exists to an inverse function of the activation function, to an inverse function of the dequantization function.

### (Supplementary Note 9)

The image processing device according to supplementary note 8,
wherein the inverse function of the dequantization function is defined such that the fixed value is set to a minimum value of possible values of a data type used in the first of the feature map and the second of the feature map.

### (Supplementary Note 10)

The image processing device according to supplementary note 7,
wherein the second generation unit is configured to:
calculate an activation value of a value of the cell that matches the fixed value by inputting a dequantized value of the cell to the activation function; and
use a predetermined value as an activation value of a value of the cell that does not match the fixed value.

### (Supplementary Note 11)

An image processing method executed by a computer, the method including:
a quantization step of generating a second image by performing quantization processing on a first image;
a first generation step of generating a feature map based on the second image;
a second generation step of generating an existence probability map indicating distribution of existence probability of an object in the first image by using the feature map;
a determination step of performing threshold value determination processing that is processing of determining whether a value of each cell is equal to or less than a lower limit threshold value for the feature map or the existence probability map; and
a dequantization step of performing dequantization processing on the feature map or the existence probability map based on a result of the threshold value determination processing.

### (Supplementary Note 12)

A program for causing a computer to execute:
a quantization step of generating a second image by performing quantization processing on a first image;
a first generation step of generating a feature map based on the second image;
a second generation step of generating an existence probability map indicating distribution of existence probability of an object in the first image by using the feature map;
a determination step of performing threshold value determination processing that is processing of determining whether a value of each cell is equal to or less than a lower limit threshold value for the feature map or the existence probability map; and
a dequantization step of performing dequantization processing on the feature map or the existence probability map based on a result of the threshold value determination processing.

Some or all of the elements (for example, configurations and functions) described in supplementary notes 2 to 8 dependent on supplementary note 1 can also be dependent on each of supplementary notes 9 to 12 by the same dependency relationship as that of supplementary notes 2 to 8. Some or all of the elements described in any supplementary note may be applied to various hardware, software, a recording unit for recording software, a system, and a method.

What is claimed is:

1. An image processing device comprising:
a quantization unit configured to generate a second image by executing quantization processing on a first image;
a first generation unit configured to generate a feature map based on the second image;
a second generation unit configured to generate an existence probability map indicating distribution of existence probability of an object in the first image by using the feature map;
a determination unit configured to perform matching determination processing that is processing of determining whether a value of each cell matches a predetermined fixed value for the feature map or the existence probability map; and
a dequantization unit configured to perform dequantization processing on the feature map or the existence probability map based on a result of the matching determination processing.

2. The image processing device according to claim 1,
wherein the dequantization unit is configured to:
when the value of the cell does not match the fixed value, dequantize the value of the cell by using a dequantization function; and
when the value of the cell matches the fixed value, use a predetermined value as a value obtained by dequantizing the value of the cell.

3. The image processing device according to claim 2,
wherein the matching determination processing and the dequantization processing are performed on the existence probability map, and
wherein the fixed value is a value obtained by inputting a probability threshold value used for determining whether an object exists to an inverse function of the dequantization function.

4. The image processing device according to claim 3,
wherein the inverse function of the dequantization function is defined such that the fixed value is set to a minimum value of possible values of a data type used in the feature map or the existence probability map.

5. The image processing device according to claim 1,
wherein the matching determination processing and the dequantization processing are performed on the feature map, and
wherein the second generation unit generates the existence probability map by using the dequantized feature map.

6. The image processing device according to claim 3,
wherein the first generation unit generates a first of the feature map and a second of the feature map,
wherein the determination unit performs the matching determination processing on each of the first of the feature map and the second of the feature map,
wherein the dequantization unit performs the dequantization processing on each of the first of the feature map and the second of the feature map, and
wherein the second generation unit is configured to:
generate a class map indicating distribution of existence probability for an object of a particular class by using the first of the feature map;
generate a centerness map indicating distribution of proximity from a center of an object by using the second of the feature map; and
generate the existence probability map for the object of the particular class by using the class map and the centerness map.

7. The image processing device according to claim 5,
wherein the second generation unit generates the existence probability map from the dequantized feature map by using an activation function.

8. The image processing device according to claim 7,
wherein the fixed value is a value obtained by inputting a value obtained by inputting a probability threshold value used for determining whether an object exists to an inverse function of the activation function, to an inverse function of the dequantization function.

9. The image processing device according to claim 8,
wherein the inverse function of the dequantization function is defined such that the fixed value is set to a minimum value of possible values of a data type used in the first of the feature map and the second of the feature map.

10. The image processing device according to claim 7,
wherein the second generation unit is configured to:
calculate an activation value of a value of the cell that matches the fixed value by inputting a dequantized value of the cell to the activation function; and
use a predetermined value as an activation value of a value of the cell that does not match the fixed value.

11. An image processing method executed by a computer, the method comprising:
a quantization step of generating a second image by performing quantization processing on a first image;
a first generation step of generating a feature map based on the second image;
a second generation step of generating an existence probability map indicating distribution of existence probability of an object in the first image by using the feature map;
a determination step of performing threshold value determination processing that is processing of determining whether a value of each cell is equal to or less than a lower limit threshold value for the feature map or the existence probability map; and
a dequantization step of performing dequantization processing on the feature map or the existence probability map based on a result of the threshold value determination processing.

12. A computer readable storage medium storing a program for causing a computer to execute a process comprising:
a quantization step of generating a second image by performing quantization processing on a first image;
a first generation step of generating a feature map based on the second image;
a second generation step of generating an existence probability map indicating distribution of existence probability of an object in the first image by using the feature map;
a determination step of performing threshold value determination processing that is processing of determining whether a value of each cell is equal to or less than a lower limit threshold value for the feature map or the existence probability map; and
a dequantization step of performing dequantization processing on the feature map or the existence probability map based on a result of the threshold value determination processing.
